(19) United States
(12) Patent Application Publication
(10) Pub. No.: US 2025/0237556 A1
(43) Pub. Date: Jul. 24, 2025

(54) METHOD AND MEASURING ARRANGEMENT FOR DETERMINING THE POSITION OF A FROST LINE IN THE MANUFACTURE OF A TUBULAR FILM OF THERMOPLASTIC MATERIAL

(71) Applicant: Kdesign GmbH, Konigswinter (DE)

(72) Inventor: Richard ZIMMERMANN, Siegburg (DE)

(73) Assignee: Kdesign GmbH, Konigswinter (DE)

(21) Appl. No.: 19/177,054

(22) Filed: Apr. 11, 2025

Related U.S. Application Data
(63) Continuation of application No. PCT/EP2022/078393, filed on Oct. 12, 2022.

(51) Int. Cl. G01K 3/14; B29C 37/00; B29C 55/28; G01B 21/10

(52) U.S. Cl. CPC G01K 3/14; B29C 37/00; B29C 55/28; G01B 21/10; B29C 2037/90

(57) ABSTRACT

A method for determining the position of a frost line of a tubular film of thermoplastic material during its manufacture, includes: detecting a temperature profile of the tubular film along a first measuring track along the axis of production; determining a first provisional position of the frost line along the first measuring track at which an absolute value of a temperature gradient of the temperature profile in the production direction falls below a first predetermined value; detecting a diameter profile of the tubular film along a second measuring track along the axis of production; determining a second provisional position of the frost line along the second measuring line at which an absolute value of a diameter gradient of the diameter profile in the production direction falls below a second predetermined value; and checking the plausibility of the first provisional position and the second provisional position based on a distance therebetween.

### CROSS-REFERENCE TO RELATED APPLICATIONS

This application is a continuation application of International Application No. PCT/EP2022/078393, filed on Oct. 12, 2022, the disclosure of which is incorporated herein by reference.

### FIELD

The present disclosure relates to a method and a measuring device for determining the position of a frost line of a tubular film of thermoplastic material emerging from a blow head and drawn off in a production direction along an axis of production during its manufacture.

### BACKGROUND

The statements in this section merely provide background information related to the present disclosure and may not constitute prior art.

During the production of a tubular film, plastic melt is extruded from an extrusion tool (blow head) with an annular channel nozzle and pulled out in the direction of an axis of production. The plasticized, plastically formable and expandable hot tubular film is blown on and cooled by cooling air from a cooling ring or an internal cooling device immediately after it emerges from the ring channel on the outer and often also on the inner circumference. The tubular film bubble is guided in direction of the axis of production over a device for guiding the tubular film (often also referred to as a guiding device, calibration device or calibration basket) and a collapsing unit, and is squeezed off and drawn off as a flat tube from conveyor rollers in a haul-off unit. The calibration device has film guide elements distributed over the circumference serving to guide the film tube. The film guide elements may, for example, have guiding rollers that contact the tubular film tangentially and guide it. The film guide elements are usually radially adjustable across the axis of production of the tubular film and can therefore be adapted to tubular films of different diameters. The position of freezing of the tubular film, i.e. the transition of the plastic melt of the tubular film from a plasticized and expandable state to a state that can no longer be expanded, is referred to as the frost line. In order to avoid the formation of marks on the tubular film by the film guide elements, the calibration device must be arranged downstream of the frost line, i.e. above the frost line in the case of a tubular film pulled vertically upwards. This means that the film guide elements of the calibrating device touch the tubular film in an area where the plastic melt has already solidified, so that the film guide elements cannot leave any marks on the tubular film. When producing a tubular film, it is therefore important to know the position of the frost line, which is often estimated by operating personnel.

The frost line does not correspond to a specific temperature (solidification temperature). The solidification point of the melt depends heavily on the formulation of the thermoplastic material and the thickness of the tubular film. The formulation determines the solidification temperature and the local thickness on the circumference of the tubular film determines the height at which the solidification temperature is reached.

The slightly different solidification points around the circumference of the tubular film due to local thickness fluctuations form the so-called frost line, which ideally appears as a horizontal line with a slightly jagged height gradient. In some transparent formulations, the frost line is faintly visible as a milky line. In the majority of productions, however, the frost line is not visually recognizable and can only be estimated based on the shape of the bubbles.

After passing through the frost line, there is no more stretching in the longitudinal and transverse directions. Accordingly, the local thickness and diameter of the tubular film remain constant downstream of the frost line.

In the tube formation zone, i.e., in the area between the exit of the plastic melt from the annular channel nozzle and the frost line, the thickness of the tubular film or the plastic melt changes continuously. The transition of the thickness of the melt or the plastic melt at the outlet of the annular channel die from usually in the range of 2,000 μm to a final thickness of usually between 6 μm and 300 μm is achieved by stretching the tubular film in the transverse and longitudinal direction.

This stretching to the final thickness is achieved by expanding the diameter due to the internal pressure in the tubular film, which is formed as a bubble, and by hauling it off in the longitudinal direction.

Stretching takes place with simultaneous cooling of the outer and/or inner side of the tubular film in the area of the tube formation zone, as described above, and ends at the frost line.

The change in thickness is determined by the continuously changing melt viscosity due to cooling. After the frost line, there is no further change in thickness or diameter. If the temperature profile of the tubular film is recorded continuously along the axis of production in the tube formation zone and across the transition to the frost line, a clear change in the temperature gradient (temperature decrease per unit of distance along the axis of production or along the measuring track) can be seen in the area of the frost line.

A method of the type mentioned at the beginning for determining the position of the frost line is known from JPH 05-138733 A, in which the position is determined at which no further temperature change takes place. This position is assumed to be the position at which the tubular film solidifies. In order to keep this position constant, a control unit regulates the volume flow of a cooling gas depending on the temperature curve.

A stable position of the frost line is essential for the process stability of the system and at the same time an indicator of a stable process.

In addition to short-term fluctuations caused by process instabilities, the frost line can also slowly change its position over a longer production period.

A frost line whose position does not match the production parameters inevitably leads to instabilities in the plastic tube formation zone, which usually manifest themselves as resonance oscillations with different amplitudes and frequencies. Such resonance vibrations lead to fluctuations in width and thickness in the end product in the direction of production, and reduce the product quality to the point of reject production.

Furthermore, the stable position of the frost line depends on the stability of those production parameters that have an effect on the frost line. For a given film format (final thickness and final width), these influencing parameters are, for example, system performance, recipe of the thermoplastic material, cooling air volume, cooling air temperature, ambient temperature and melt temperature. Fluctuations in the above parameters inevitably lead to fluctuations in the position of the frost line.

If an initially stable position of the frost line is suddenly subject to such fluctuations, it can be assumed that one or more of the afore-mentioned parameters are also subject to fluctuations. These fluctuations are not always short-term or dynamic. A change in the ambient temperature in the production hall, for example, leads to a slow drifting of the frost line. In general, any shift in the frost line during production is undesirable and leads to malfunctions or quality problems.

As plant automation progresses and more and more extensive production parameter databases are used to optimize production and minimize rejects, the position of the tube formation zone or frost line plays a key role. The position of the frost line must be determined and monitored without errors for largely complete system automation.

Such error-free determination also opens up the possibility of implementing control loops that correct the position of the frost line in the event of deviations. Control loops that act on one or more of the afore-mentioned process parameters are suitable for this purpose.

The basic prerequisite for such control circuits is precise knowledge of the position of the frost line and continuous and error-free monitoring of this position.

### SUMMARY

This section provides a general summary of the disclosure and is not a comprehensive disclosure of its full scope or all of its features.

It is an aspect of the present disclosure to provide a method and a measuring arrangement which enable the position of the frost line to be reliably determined.

The object is achieved by a method for determining the position of a frost line of a tubular film of thermoplastic material emerging from a blow head and drawn off in a production direction along an axis of production during its manufacture. The method comprises the steps of detecting a temperature profile of the tubular film along a first measuring track along the axis of production, determining a position along the first measuring track at which an absolute value of a temperature gradient of the temperature profile in the production direction falls below a predetermined limit value, and defining the position as the first provisional position of the frost line. In addition, a diameter profile of the tubular film is recorded along a second measuring track along the axis of production. A position along the second measuring track is then determined at which an absolute value of a diameter gradient of the diameter profile in the production direction falls below a predetermined limit value and this position is set as the second provisional position of the frost line. Finally, the plausibility of the first provisional position and the second provisional position of the frost line is checked on the basis of their distance from each other.

To assess the distance between the first provisional position and the second provisional position during the plausibility check, for example, a difference between one of the provisional positions and the other of the two provisional positions can be determined. It is also conceivable to form the quotient of the two provisional positions and determine a deviation from the numerical value 1 or a percentage deviation from the numerical value 1. A percentage deviation of one of the provisional positions from the other of the two provisional positions can also be determined. It is also possible to determine the distance between one or both provisional positions and a mean value of the two provisional positions, also in the form of a difference or a percentage deviation. In principle, of course, other mathematical calculation methods known to the skilled person are also conceivable, which provide a measure of the distance between the two preliminary positions.

The plausibility of the position of the frost line is thus checked by means of two independent parameters, namely by means of the temperature curve on the one hand and by means of the diameter curve on the other. These two independent parameters can be used, for example, to check whether the determined preliminary positions of the frost line can be used for fully automated process control. This provides a redundant system that avoids using an inaccurate or incorrect position of the frost line for fully automated process control and producing rejects.

The first provisional position is defined by the fact that the absolute value, i.e. a value independent of the mathematical sign, of the temperature gradient in the production direction falls below a predetermined limit value. The first preliminary position can be determined by any mathematical method, as long as the condition is met that the absolute value of the temperature gradient of the temperature curve in the production direction falls below a predetermined limit value. For example, it is also possible to check the temperature gradient of the temperature curve against the production direction to see whether its absolute value exceeds the predetermined limit value. The same applies analogously to the definition of the second provisional position.

In addition, a final position of the frost line can be determined using the first provisional position and the second provisional position of the frost line.

In practice, when recording the temperature curve and the diameter curve, there is noise in the signal due to measurement deviations, as is usual in measurement technology. This can cause the measured values to fall below the corresponding predetermined limit value locally and briefly before the frost line is actually reached. For this purpose, the person skilled in the art will process the signal accordingly, for example by smoothing the raw data curve before the preliminary positions are determined, as is common and known in measurement technology.

As explained above, the temperature of the tubular film decreases in the direction of production within the tube formation zone. In the area of the frost line, the temperature decrease slows down significantly, although this depends on the ambient conditions, the formulation of the plastic melt and similar factors. To determine the first preliminary position of the frost line, the transition from a negative temperature gradient with a high absolute value to a temperature gradient with a low absolute value, possibly close to zero, can be determined when viewed in the production direction.

A distance between a diameter measuring unit and the tubular film can be measured to record the diameter profile. Detecting the distance of a diameter measuring unit from a surface of the tubular film is the same as detecting the diameter profile of the tubular film, as the distance to the surface of the tubular film depends on the diameter of the tubular film. The distance between a diameter measuring unit and the surface of the tubular film decreases as the diameter of the tubular film increases. The diameter of the tubular film and the distance of a diameter measuring unit from a surface of the tubular film are therefore to be regarded as equivalent for the purposes of the present disclosure.

When checking plausibility, plausibility can be affirmed if the distance between the first and second provisional positions of the frost line is below a predetermined limit value. It is therefore only assumed that the preliminary positions of the frost line are plausible if they are sufficiently close to each other and not too far apart.

The position of the frost line can basically be any position from the first provisional position of the frost line to the second provisional position of the frost line. For example, it is possible to determine one of the two provisional positions of the frost line as the final position of the frost line and to use the respective other provisional position of the frost line only for plausibility check purposes.

However, it is also conceivable to determine an average value of the first and second provisional positions of the frost line and set this as the final position of the frost line. This ensures that even if one of the two provisional positions deviates significantly from the actual position of the frost line, the influence of this deviation on the process control is mitigated by the additional consideration of the other provisional position. However, any other mathematical definition is just as conceivable.

To ensure that the area of the frost line is completely covered by at least one of the two measuring tracks, the first measuring track and the second measuring track can be arranged in an area in which the tubular film transitions from an area with a changing diameter to an area with a constant diameter. The frost line is, predictably, in this area.

In an exemplary method, it may be provided that the temperature profile is detected by means of a non-contact temperature sensor which is moved along the first measuring track and/or that the diameter profile is detected by means of a non-contact distance sensor which is moved along the second measuring track.

In principle, it is also conceivable that the temperature profile is measured along several first measuring tracks distributed around the circumference of the tubular film and/or that the diameter profile is measured along several second measuring tracks distributed around the circumference of the tubular film. The preliminary positions of the frost line determined over the circumference can be used for averaging. On the other hand, an arrangement of the measuring tracks distributed around the circumference also makes it possible to detect a skew of the frost line relative to the axis of production and to determine the extent of the skew.

The object is achieved additionally by a measuring device for determining the position of a frost line of a tubular film of thermoplastic material emerging from a blow head and drawn off in a production direction along an axis of production during its manufacture. The measuring device comprises a temperature measuring unit, which is configured to detect a temperature profile of the tubular film along a first measuring track along the axis of production, and a processing unit, which is configured to determine a position along the first measuring track at which an absolute value of a temperature gradient of the temperature profile in the production direction falls below a predetermined limit value, and to define the position as the first provisional position of the frost line. Furthermore, the measuring device has a diameter measuring unit for measuring the diameter of the tubular film along a second measuring track along the axis of production. A processing unit is configured to determine a position along the second measuring track at which an absolute value of a diameter gradient of the diameter profile in the production direction falls below a predetermined limit value, and to define this position as the second provisional position of the frost line. Furthermore, the measuring device has a processing unit which is configured to check the plausibility of the first provisional position and the second provisional position of the frost line on the basis of their distance from one another.

Further, the measuring device may comprise a processing unit configured to determine a final position of the frost line based on the first provisional position and the second provisional position of the frost line.

The processing unit for determining and setting the first provisional position, the processing unit for determining and setting the second provisional position, the processing unit for checking plausibility and the processing unit for determining the final position can be represented by a single processing unit, for example a computer or a circuit board with programmable components. Each processing unit can have a memory for storing measurement data when recording the temperature profile and the diameter profile and a processor unit for processing the measurement data when determining the first and second provisional positions, when checking plausibility and/or when determining the final position.

The diameter measuring unit may be configured to measure a distance between the diameter measuring unit and the tubular film in order to detect the diameter profile of the tubular film.

In one embodiment of the measuring arrangement, the temperature measuring unit can comprise a non-contact temperature sensor that is driven to move along the first measuring track. Furthermore, alternatively or additionally, the diameter measuring unit may comprise a non-contact distance sensor which is driven to move along the second measuring track.

For this purpose, the measuring device may comprise a sensor carriage which is driven to move along the first measuring track and the second measuring track and on which the temperature sensor and the distance sensor are mounted. The sensor carriage can be driven by a spindle, toothed rack and pinion or belt drive, for example.

In order to protect the measuring arrangement from external influences, it can have a housing in which the sensor carriage is movably arranged and which has a slot facing the tubular film that is aligned with the temperature sensor and/or the distance sensor. This means that all components are protected in the housing and can only be accessed via the slot.

In an embodiment, there are several temperature measuring units arranged around the circumference and/or several diameter measuring units arranged around the circumference.

According to a specific embodiment example, the measuring system has a calibration device, for example a calibration basket, for guiding the tubular film. The calibrating device has a frame which is designed to be height-adjustable along an axis of production relative to the blowing head, a plurality of carrier arms which are arranged distributed around the circumference of the frame and are synchronously adjustable in diameter relative to the axis of production, with guide elements for guiding the tubular film, and adjustment means for adjusting the carrier arms. The measuring device is attached to the adjustable carrier arms, to the adjustment means or to the frame of the calibration device.

As the height of the calibration device is set so that it is located behind the tube formation zone when viewed in the direction of production, the arrangement of the measuring device on the calibration device ensures that the measuring device is always arranged in the area of the frost line and is moved to the corresponding position together with the calibration basket depending on the process parameters. In this case, the measuring device is to be arranged before the tubular film enters the calibrating device when viewed in the production direction.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a vertical section of a blown film extrusion line with a measuring arrangement;

FIG. 2 shows a view of a calibration device of the blown film extrusion line according to FIG. 1 in the direction of an axis of production;

FIG. 3 shows a graph of a temperature curve and a diameter curve of the tubular film over the distance to the blowing head;

FIG. 4 shows a graph of a temperature curve and a curve of the distance between a diameter measuring unit and the tubular film over the distance to the blowing head;

FIG. 5 shows a perspective view of a measuring device; and

FIG. 6 shows a perspective view of the measuring device shown in FIG. 5 without the housing.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

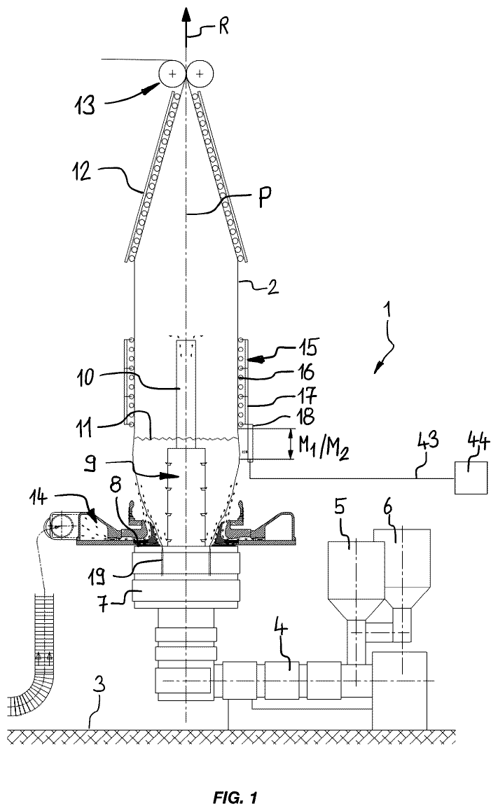

FIG. 1 shows a complete blown film extrusion line 1 for producing a tubular film 2 in a production direction R vertically upwards along an axis of production P in vertical section. An extruder 4 for thermoplastics stands on a base 3, on which two feed hoppers 5, 6 can be seen. The thermoplastic material fed in granular form via the feed hoppers 5, 6 is plasticized and homogenized by pressure and additional heating means in a screw of the extruder 4 and pressed into a blow head 7, adjoining the extruder 4, with vertical axis. The blow head 7 has an annular channel nozzle 19 on its upper side 8, shown here schematically, from which the expanding tubular film 2, which is initially still plasticized and thermoplastic, emerges symmetrically to an axis of production P. An internal cooling device 9, via which cooling gas is fed into the tubular film 2, and a gas extraction pipe 10 are fitted centrally on the blow head 7. This creates an internal pressure in the tubular film 2, as a result of which the tubular film 2 initially expands and, at a frost line 11, changes to a state in which the plastic melt solidifies and further plastic deformation of the material of the tubular film 2 is no longer possible. As a result of the internal overpressure, which also serves to stabilize it, and by hauling off the tubular film 2, the tubular film material is first stretched circumferentially and longitudinally, which is prevented all the more quickly the more the tubular film material is cooled.

After solidification of the plastic material of the tubular film 2 in the area of the frost line 11, it essentially retains its diameter. The tubular film 2 is pulled further upwards along the axis of production P in the haul-off direction and pressed flat in a collapsing unit 12 and guided away upwards via a haul-off unit 13. The flattened tubular film 2 is then wound onto coils (not shown here).

A cooling gas ring 14 with internal outlet nozzles is arranged directly above the blow head 7, from which cooling gas, usually air, flows out and flows onto the tubular film 2, which is under increased internal pressure, in a ring shape essentially parallel to the surface of the tubular film 2. The tubular film 2 plasticized in this area initially expands in diameter under the afore-mentioned pressure inside until it hardens under the action of the cooling gas and assumes a constant diameter. Above the frost line 11, i.e. downstream of the frost line 11 in the haul-off direction, there is a calibration device 15, shown only schematically in FIG. 1, in the form of a calibration basket with several guide elements in the form of guide rollers 16 coming into contact with the tubular film 2, which are arranged in a ring around the axis of production P and around the circumference of the tubular film 2. In order to enable adaptation to tubular films 2 of different diameters, the guide rollers 16 are attached to a frame 17 so as to be adjustable at least approximately radially to the axis of production P. For this purpose, the guide rollers 16 are rotatably mounted on carrier arms (not shown here). The carrier arms can be adjusted, for example pivoted or moved linearly, via adjustment means not shown here in such a way that the guide rollers 16 can be adjusted at least essentially radially to the axis of production P.

A measuring device 18 is attached to the calibration device 15, wherein the measuring device 18 can be attached to one of the carrier arms, to one of the adjustment means or to the frame 17 of the calibration device 15. The measuring device 18 comprises a temperature measuring unit for detecting a temperature profile of the tubular film 2 along a first measuring track M1 along the axis of production P, wherein the first measuring track M1 extends beyond the frost line 11, i.e. crosses it. In the embodiment example shown, the first measuring track M1 runs parallel to the axis of production P. However, the first measuring track M1 can also be arranged at an angle to the axis of production P, as long as the temperature profile of the tubular film 2 can be detected over a sufficient range along the axis of production P.

In addition, the measuring device 18 comprises a diameter measuring unit for detecting a diameter profile of the tubular film 2 along a second measuring track M2 along the axis of production P, wherein the second measuring track M2 also extends beyond the frost line 11, i.e. crosses it. In the embodiment example shown, the second measuring track M2 also runs parallel to the axis of production P. The second measuring track M2 can also be arranged at an angle to the axis of production P, as long as the diameter profile of the tubular film 2 can be detected over a sufficient range along the axis of production P.

Detecting the course of the diameter of the tubular film 2 is equivalent to detecting the distance of the measuring device 18 or the diameter measuring unit from a surface of the tubular film 2, since the distance to the surface of the tubular film 2 depends on the diameter of the tubular film 2.

The first measuring track M1 and the second measuring track M2 can be arranged parallel to each other, wherein this includes the two measuring tracks M1 and M2 being identical or overlapping.

The measuring device 18 is connected to a processing unit 44, for example a computer, via a data line 43, which may be a wired or wireless data line. However, the processing unit 44 can also be integrated into the measuring device 18, for example in the form of a circuit board with programmable components.

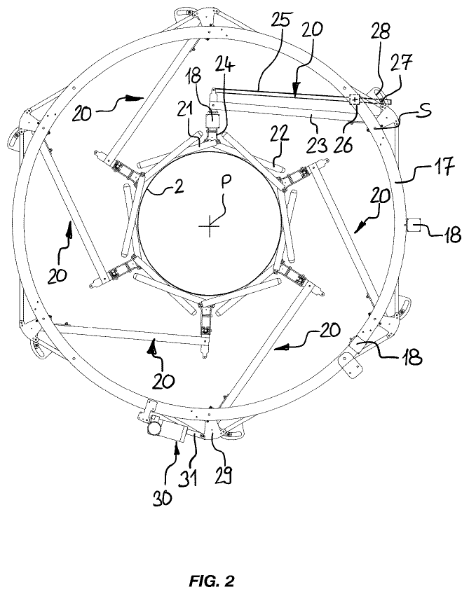

FIG. 2 shows a view of the calibration device 15 in the direction of the axis of production P for guiding the tubular film 2. The movable elements described below are attached to the frame 17 of the calibration device 15, the frame 17 being arranged so as to be adjustable in height relative to the blow head. The frame 17 forms a central passage through which the tubular film 2 is guided parallel to the axis of production P. There are six adjusting units 20 distributed around the circumference. The adjustment units 20 are used to adjust film guide elements 21, 22 in a direction radial to the axis of production P. One of the six adjustment units 20 is described below as an example, whereby all adjustment units 20 have an identical design.

The adjusting units 20 each include a carrier arm 23 pivotally attached to the frame 17. The carrier arm 23 can be pivoted about a pivot axis S, which is arranged parallel to the axis of production P.

Furthermore, the adjusting units 20 each have a carrier 24 which, in the shown embodiment, carries two film guide elements 21, 22 in the form of guide rollers which, viewed in the direction of the axis of production P, are spaced apart from each other and are arranged to overlap in a V-shape. The carrier 24 is pivotably connected to the carrier arm 23 about a pivot axis, whereby the pivot axis is arranged parallel to the axis of production P.

Further, the adjusting units 20 each include a coupling rod 25 pivotally connected to the carrier 24.

Finally, the adjusting units 20 each comprise an actuating mechanism by means of which the coupling rod 25 is pivotally connected to the frame 17.

The coupling rod 25 of the adjustment unit 20 is connected to the frame 17 in a pivoting and sliding manner via a coupling element 26. The coupling element 26 is rotatably connected to the frame 17, whereby the coupling rod 25 is slidably coupled to the coupling element 26. For the sake of clarity, the coupling rod 25 and the coupling element 26 are only shown for one of the adjustment units 20.

In addition, a cam follower 27 is attached to the coupling rods 25 and is guided along a guide 28 on the frame 17 for translational movement. In the embodiment shown, the guide 28 is a groove in a plate 29 that is fixedly attached to the frame 17. The guide 28 is curved and designed in such a way that the carrier 24 is always centered on the axis of production P, regardless of the distance to the axis of production P or to the tubular film 2. This ensures that the film guide elements 21, 22 in the form of the two guide rollers are precisely centered relative to the tubular film 2, so that both rollers are always in contact with the tubular film 2.

The coupling element 26, the follower 27 and the guide 28 together form adjustment means via which the coupling rod 25 is connected to the frame 17 and the carrier arm 23 is adjusted.

The carrier arm 23 is fixedly connected to a pivot plate 29, which is pivotably attached to the frame 17 about the pivot axis S, so that the carrier arm 23 is pivotably arranged on the frame 17 via the pivot plate 29. A drive 30 is also attached to the frame 17. The drive 30 is in the form of a solenoid, by means of which an actuator 31 in the form of a piston rod can be driven linearly. Here, the actuator 31 is pivotally connected to the pivot plate 29 of one of the adjusting units 20. Further, a housing of the drive 30 is pivotally connected to the frame 17. The drive 30 is thus supported against the frame 17, and the carrier arm 23 can be pivoted by adjusting the actuator 31. If the actuator 31 is moved from a pushed-in position to a pushed-out position, the carrier arm 23, which is connected to the drive 30 via the pivot plate 29, is pivoted inwards so that the film guide elements 21, 22 enclose a smaller diameter and can thus guide a tubular film 2 with a smaller diameter.

The calibration device 15 includes a synchronization mechanism to synchronize the movement of all adjusting units 20. The synchronization mechanism includes push rods 32, each of which couples the pivot plates 29 together about the circumference of adjacent adjusting units 20. For this purpose, the push rods 32 are each pivotally connected to the two pivot plates 29 of adjacent adjusting units 20. This means that the pivot movement of the adjustment unit 20 connected to the drive 30 is transmitted to the other adjustment units 20 so that all adjustment units 20 are moved synchronously.

The measuring device 18 is shown in three different positions. In a first position, the measuring device 18 is arranged radially outside the frame 17 and is firmly connected to the frame 17. In a second position, the measuring device 18 is aligned with the frame 17 as viewed along the axis of production P and is attached to it. In a third position, the measuring device 18 is located on a carrier 24 of one of the adjustment units 20. At all three positions, it is ensured that the measuring device 18 together with the entire calibration device 15 can be adjusted in height relative to the blow head so that the measuring device 18 can always be arranged in the area of the frost line. In the third position, in which the measuring device 18 is connected to a carrier 24 of one of the adjustment units 20, the measuring device 18 is also adjusted relative to the axis of production P when the film guide elements 21, 22 are radially adjusted. This ensures that the measuring device 18 always has a constant radial distance to the tubular film 2, which can increase the measuring accuracy.

The three positions shown can alternatively be used as the attachment position of the measuring device 18. However, it is also conceivable that these positions are used in different combinations for the arrangement of the measuring device 18. In addition, several measuring devices 18 can be arranged around the circumference in order to be able to determine, for example, an inclination of the frost line relative to the axis of production P.

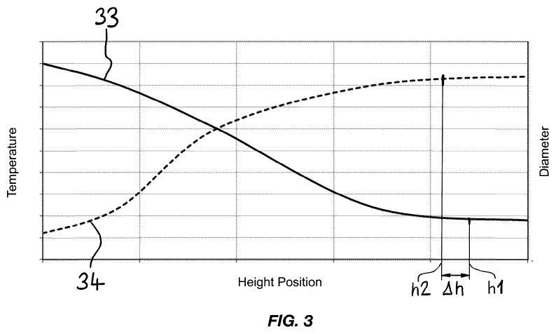

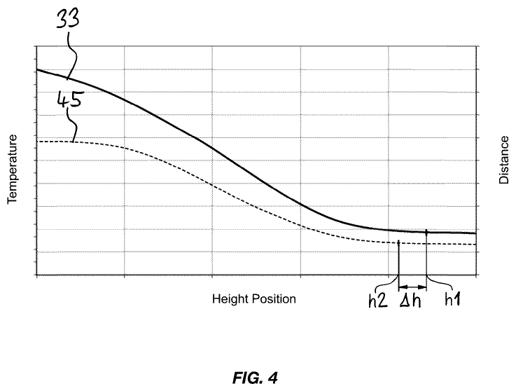

FIG. 3 shows a graph of a temperature curve 33 and a diameter curve 34 of the tubular film. On the abscissa axis (X-axis), the distance to the blow head (height position) is plotted in ascending order from left to right. The temperature and the diameter of the tubular film are plotted on the ordinate axis (Y-axis) in ascending order from bottom to top. Instead of the diameter profile 34, the profile of the distance 45 between the diameter measuring unit and the tubular film can also be plotted, as shown in FIG. 4. These two values correlate with each other and are to be considered synonymous for the purposes of the present disclosure.

It can be seen that as the distance to the blow head increases, the temperature 33 initially decreases rapidly and continuously and from a certain height position decreases only slightly or remains almost constant. The diameter 34 of the tubular film increases rapidly and continuously in the direction of higher height positions, with the distance 45 between the diameter measuring unit and the tubular film decreasing in inverse proportion. From a certain height position, the values change only slightly or both values remain almost constant.

At a height position h1, the absolute value of the temperature gradient of the temperature curve 33 falls below a predetermined limit value in the present case. The temperature gradient corresponds to the gradient of the temperature curve 33 and is used as an absolute value without a sign for simplification purposes. If the temperature falls below a predetermined limit value, it can therefore be assumed that the temperature 33 decreases sufficiently slowly to be able to assume the position of the frost line. This altitude position is determined as the first preliminary position h1 of the frost line.

In the present case, at a height position h2, the absolute value of the diameter gradient of the diameter profile 34 or the absolute value of the distance gradient of the profile of the distance 45 between the diameter unit and the tubular film falls below a predetermined limit value. The diameter gradient and the distance gradient correspond to the gradient of the diameter curve 34 and the curve of the distance 45 between the diameter measuring unit and the tubular film and can also be used as an absolute value without a sign for simplification purposes. If the diameter falls below a predetermined limit value, it can therefore be assumed that the diameter 34 increases sufficiently slowly or the distance 45 between the diameter measuring unit and the tubular film decreases sufficiently slowly to be able to assume the position of the frost line. This altitude position is determined as the second preliminary position h2 of the frost line.

The plausibility of these two measured values can be checked using the two preliminary positions h1, h2 of the frost line. For example, the distance Δh between the two preliminary positions h1, h2 can be calculated. As long as the distance Δh does not exceed a predetermined limit value, plausibility can be affirmed. In this case, for example, one of the two provisional positions h1, h2 can be determined as the final position of the frost line or any value in between, for example the mean value of the two provisional positions h1, h2.

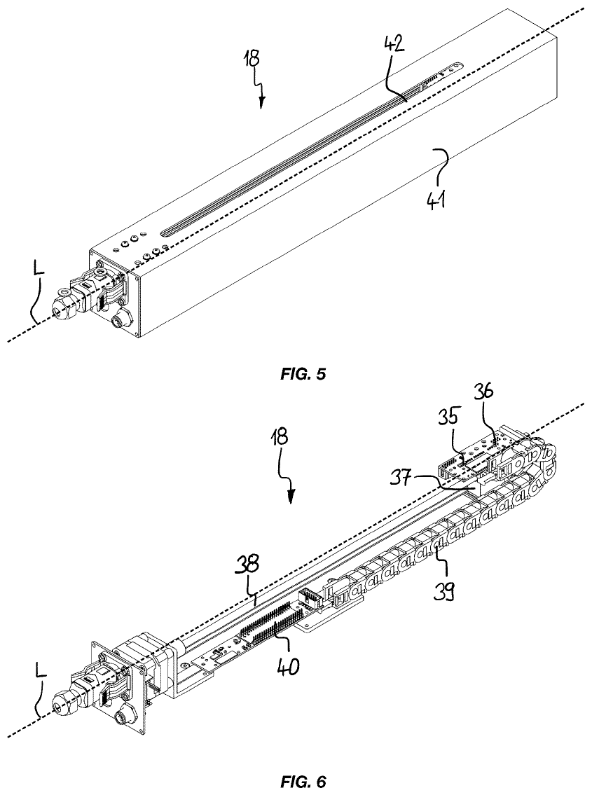

FIGS. 5 and 6 show different perspective views of the measuring device 18 and are described together below.

The measuring device 18 has a non-contact temperature sensor 35 and a non-contact distance sensor 36, which are mounted on a sensor carriage 37. In the embodiment example shown, the sensor carriage is driven to move along a longitudinal axis L via a spindle 38. Alternatively, a drive via a toothed rack or a belt drive as well as other drive concepts for linear adjustment of the sensor carriage 37 are also conceivable. The temperature sensor 35 and the distance sensor 36 are arranged one behind the other parallel to the longitudinal axis L, so that the first measuring track of the temperature sensor 35 and the second measuring track of the distance sensor 36 partially overlap and are offset from each other in the direction of the longitudinal axis L by the axial distance between the temperature sensor 35 and the distance sensor 36.

The temperature sensor 35 and the distance sensor 36 are connected to electrical components 40 via electrical cables, which are routed in a cable guide 39. The entire arrangement is contained in a housing 41 and protected from the outside. The housing 41 has a slot 42 which runs parallel to the longitudinal axis L in the housing 41 and is aligned with the temperature sensor 35 and the distance sensor 36, so that these can determine the temperature and the distance of the tubular film from inside the housing 41.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for determining a position of a frost line of a tubular film of thermoplastic material emerging from a blow head and drawn off in a production direction along an axis of production during its production, the method comprising:
detecting a temperature profile of the tubular film along a first measuring track along the axis of production;
determining a first provisional position of the frost line, the first provisional position being a position along the first measuring track at which an absolute value of a temperature gradient of the temperature profile in the production direction falls below a first predetermined value;
detecting a diameter profile of the tubular film along a second measuring track along the axis of production;
determining a second provisional position of the first line, the second provisional position being a position along the second measuring line at which an absolute value of a diameter gradient of the diameter profile in the production direction falls below a second predetermined value; and
checking plausibility of the first provisional position and the second provisional position of the frost line based on a distance therebetween.

2. The method according to claim 1, wherein a final position of the frost line is determined based on the first provisional position and the second provisional position of the frost line.

3. The method according to claim 1, further comprising measuring a distance between a diameter measuring unit and the tubular film to detect the diameter profile.

4. The method according to claim 1, wherein the plausibility of the first provisional position and the second provisional position of the frost line is affirmed if the distance between the first provisional position and the second provisional position of the frost line is below a third predetermined value.

5. The method according to claim 1, further comprising determining a final position of the frost line based on the first provisional position, the second provisional position or a position between the first provisional position and the second provisional position.

6. The method according to claim 1, further comprising determining a final position of the frost line based on an average value of the first provisional position and the second provisional position of the frost line.

7. The method according to claim 1, wherein the first measuring track and the second measuring track are arranged in an area in which the tubular film changes from an area with a changing diameter to an area with a constant diameter.

8. The method according to claim 1, further comprising at least one of
detecting the temperature profile by means of a non-contact temperature sensor, which is moved along the first measuring track, and
detecting the diameter profile by means of a non-contact distance sensor, which is moved along the second measuring track.

9. The method according to claim 1, further comprising at least one of
measuring the temperature profile along a plurality of first measuring tracks distributed around a circumference of the tubular film, and
measuring the diameter profile along several second measuring tracks distributed around the circumference of the tubular film.

10. A measuring arrangement for determining a position of a frost line of a tubular film of thermoplastic material emerging from a blow head and drawn off in a production direction along an axis of production during its production, with a measuring device comprising:
a temperature measuring unit configured to detect a temperature profile of the tubular film along a first measuring track along the axis of production;
a processing unit configured to determine a first provisional position of the frost line, the first provisional position being a position along the first measuring track at which an absolute value of a temperature gradient of the temperature profile in the production direction falls below a first predetermined value;
a diameter measuring unit configured to detect a diameter profile of the tubular film along a second measuring track along the axis of production,
wherein the processing unit is further configured to:
determine a second provisional position of the frost line, the second provisional position being a position along the second measuring track at which an absolute value of a diameter gradient of the diameter profile in the production direction falls below a second predetermined value; and
check plausibility of the first provisional position and the second provisional position of the frost line based on a distance therebetween.

11. The measuring arrangement according to claim 10, wherein the processing unit is further configured to determine a final position of the frost line based on the first provisional position and the second provisional position of the frost line.

12. The measuring arrangement according to claim 10, wherein the diameter measuring unit is configured to measure a distance between the diameter measuring unit and the tubular film in order to detect the diameter profile of the tubular film.

13. The measuring arrangement according to claim 10,
wherein the temperature measuring unit comprises a non-contact temperature sensor which is driven movably along the first measuring track, and/or
wherein the diameter measuring unit comprises a non-contact distance sensor which is driven movably along the second measuring track.

14. The measuring arrangement according to claim 13, wherein the measuring device comprises a sensor carriage which is driven to move along the first measuring track and the second measuring track and on which the temperature sensor and the distance sensor are mounted.

15. The measuring arrangement according to claim 14, wherein the sensor carriage is driven via a spindle, a rack or a belt drive.

16. The measuring arrangement according to claim 14, wherein the measuring device has a housing in which the sensor carriage is arranged so as to be movable and which has a slot facing the tubular film, said slot being aligned with at least one of the temperature sensor and the distance sensor.

17. The measuring arrangement according to claim 10, wherein several temperature measuring units and/or several diameter measuring units are distributed around a circumference of the tubular film.

18. The measuring arrangement according to claim 10, wherein the measuring arrangement has a calibration device for guiding the tubular film, the calibration device comprising:
a frame which is designed to be height-adjustable along the axis of production relative to the blow head;
a plurality of carrier arms with film guide elements for guiding the tubular film, which are arranged distributed over a circumference of the frame and are synchronously adjustable in diameter relative to the axis of production; and
adjusting means for adjusting the carrier arms;
wherein the measuring device is attached to the adjustable carrier arms, to the adjustment means, or to the frame of the calibration device.

19. The measuring arrangement according to claim 18, wherein the measuring device is arranged in the production direction upstream of an inlet of the tubular film into the calibrating device.
